(19) United States
(12) Patent Application Publication
(10) Pub. No.: US 2022/0009529 A1
(43) Pub. Date: Jan. 13, 2022

(54) RAIL VEHICLE BODY STRUCTURE

(71) Applicant: CRRC QINGDAO SIFANG CO., LTD., Qingdao, Shandong (CN)

(72) Inventors: Sansan DING, Qingdao, Shandong (CN); Haiting LIANG, Qingdao, Shandong (CN); Lianhe ZHANG, Qingdao, Shandong (CN); Wanjing WANG, Qingdao, Shandong (CN); Aiqin TIAN, Qingdao, Shandong (CN)

(73) Assignee: CRRC QINGDAO SIFANG CO., LTD., Qingdao, Shandong (CN)

(21) Appl. No.: 17/288,533

(22) PCT Filed: Apr. 22, 2020
(86) PCT No.: PCT/CN2020/086012

§ 371 Date: Apr. 25, 2021

(30) Foreign Application Priority Data
Jun. 21, 2019 (CN) 201910542773.5

(51) Int. Cl. B61D 17/04; B61D 17/08

(52) U.S. Cl. CPC B61D 17/045; B61D 17/08

(57) ABSTRACT

A rail vehicle body structure, comprising: a tubular corrugated plate; an annular beam and an underframe cross beam sleeved within the corrugated plate; and underframe side beams provided between the annular beam and the underframe cross beam. The two sides of the bottom of the corrugated plate are symmetrically provided with connection parts, and the underframe side beam is disposed on the outside of the connection part.

The present application claims the priority to Chinese Patent Application No. 201910542773.5, titled “RAIL VEHICLE BODY STRUCTURE”, filed with the China National Intellectual Property Administration on Jun. 21, 2019, which is incorporated herein by reference in its entirety.

### FIELD

The present application relates to the technical field of rail vehicles, and in particular to a body structure of a rail vehicle.

### BACKGROUND

With the continuous increase of the rail transit speed, a series of problems such as high resistance, high energy consumption, high vibration and high noise have been brought to the train. To solve these problems, it is necessary to improve the strength and optimize the structure of a train on the basis of lightweight. The traditional metal material vehicle body structure has limited lifting space to solve the above problem. Thus, new lighter and stronger material is required.

In addition, the existing vehicle body structure of the rail vehicle has many modules and a large assembly amount, and a large number of modules are connected by rivets, the processing amount of the rivet holes is large and it is easy to leak rain; a large number of metal connectors are used, and the weight is increased.

Therefore, how to provide a rail vehicle body structure with a high degree of lightness, a small number of parts, and a greatly reduced assembly volume is an important technical problem to be solved by those skilled in the art.

### SUMMARY

In order to solve the above technical problems, the present application provides a rail vehicle body structure, the rail vehicle body structure has a high degree of lightweight and a small number of parts and may greatly reduce the amount of assembly.

In order to solve the above technical problems, the present application provides a rail vehicle body structure, the rail vehicle body structure includes a cylindrical corrugated plate;

an annular beam and an underframe cross beam sleeved inside the corrugated plate; and,

an underframe side beam arranged between the annular beam and the underframe cross beam;

a pair of interface parts are symmetrically arranged on both sides of a bottom of the corrugated plate, and the underframe side beam is arranged outside the pair of interface parts.

Optionally, a connecting plate is provided on an inner side of a bottom of the rail vehicle body structure.

Optionally, the annular beam and the connecting plate are connected by rivets or bolts, and the underframe side beam, the corrugated plate and the connecting plate are connected by rivets or bolts.

Optionally, a sealant is coated between the annular beam and the connecting plate, and between the underframe side beam, the corrugated plate and the connecting plate.

Optionally, a skin is laid on an outside of the corrugated plate and the underframe side beam.

Optionally, multiple ribs are provided on the corrugated plate.

Optionally, the annular beam and the underframe cross beam are provided with a rib passage notch at a positions corresponding to each of the multiple ribs.

Optionally, the underframe side beam is riveted with an equipment mounting part, and the equipment mounting part is provided with a sliding groove.

Optionally, the corrugated plate, the annular beam, the underframe cross beam, the underframe side beam and the skin are all made of carbon fiber composite materials.

Compared with the above background technology, the rail vehicle body structure provided by the present application has the following beneficial effects:

1. using carbon fiber composite materials, the vehicle body is light in weight.

2. the cross-section is a cylindrical overall structure with no joints and good air tightness.

3. the cylindrical overall structure has a high degree of automation during manufacture and high production efficiency.

4. the number of parts is small and the assembly volume is low.

### BRIEF DESCRIPTION OF THE DRAWINGS

FIG. 1 is a cross-sectional view of a rail vehicle body structure provided by a specific embodiment of the present application;

FIG. 2 is a partial enlarged view of position A in FIG. 1;

FIG. 3 is a cross-sectional view of the skin of the rail vehicle body structure provided by a specific embodiment of the present application;

FIG. 4 is a cross-sectional view of a corrugated plate of a rail vehicle body structure provided by a specific embodiment of the present application;

FIG. 5-1 and FIG. 5-2 are respectively partial enlarged views of positions 11 and 12 in FIG. 4;

FIG. 6 is a cross-sectional view of an annular beam of a rail vehicle body structure provided by a specific embodiment of the present application;

FIG. 7 is a cross-sectional view of an underframe cross beam of a rail vehicle body structure provided by a specific embodiment of the present application;

FIG. 8 is a cross-sectional view of an underframe side beam of a rail vehicle body structure provided by a specific embodiment of the present application.

Reference numerals are listed as follows,

| | |
|---|---|
| 1 corrugated plate; | 11 rib; |
| 12 interface part; | 2 annular beam; |
| 3 underframe cross beam; | 21, 31 rib passage notch; |
| 4 underframe side beam; | 5 skin; |
| 6 connecting plate; | 7 equipment mounting part; |
| 71 sliding groove. | |

### DETAILED DESCRIPTION OF THE EMBODIMENTS

In order to provide those skilled in the art a better understanding of the solutions of the present application, the present application is described hereinafter in further detail in conjunction with the drawings and embodiments.

In the description of the present application, it is to be understood that the orientation or positional relationships indicated by terms “center”, “longitudinal”, “lateral”, “length”, “width”, “thickness”, “up”, “down”, “front”, “rear”, “left”, “right”, “vertical”, “horizontal”, “top”, “bottom”, “inner”, “outer”, “clockwise”, “anticlockwise” and the like are based on the orientation or positional relationships shown in the drawings, and are merely for the convenience of describing the present application and the simplification of the description, and do not indicate or imply that the device or member referred to must be in a particular orientation, or be constructed and operated in a particular orientation, and therefore should not be construed as a limitation to the scope of the present application.

In addition, the terms “first”, “second” and the like are for purpose of description, and should not be interpreted as indicating or implying relative importance or implying the number of the indicated technical features. Therefore, the features defined by “first” and “second” may explicitly or implicitly include one or more of the features. In the description of the present disclosure, the meaning of “multiple” is two or more, unless specifically defined otherwise.

In the description of the present application, it should be pointed out that, terms “install”, “link”, “connect” and “fix” should be understood broadly, unless otherwise specifically defined. For example, it can be fixedly connected or detachably connected or integrally connected; it can be mechanically connected or electrically connected; it can be directly connected or indirectly connected through intermediate media, or inner parts of two components are in communication with each other. For those skilled in the art, the specific meaning of the above terms in the present application may be understood in the light of specific circumstances.

A core of the present application is to provide a rail vehicle body structure. The rail vehicle body structure has a high degree of lightweight, a small number of parts, and may greatly reduce the amount of assembly.

In order to provide those skilled in the art with a better understanding of the solutions of the present application, the present application will be described hereinafter in further detail in conjunction with the drawings and specific embodiments.

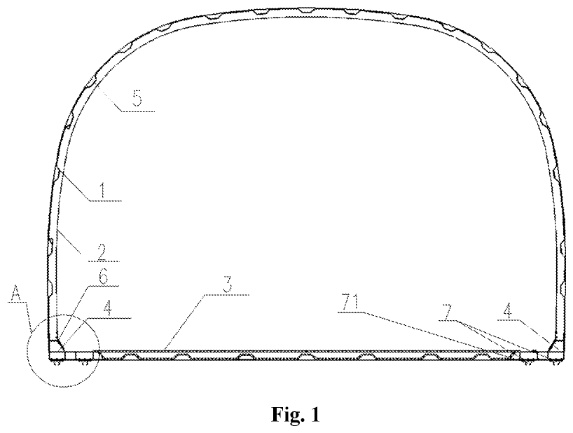

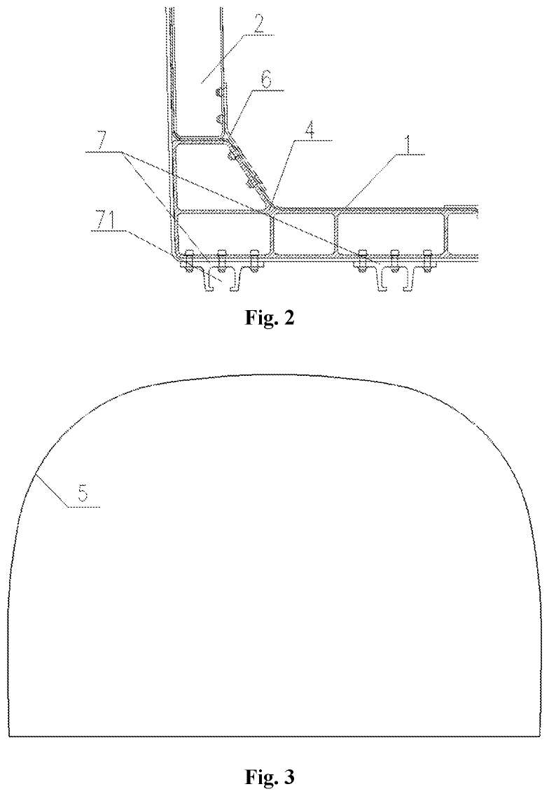

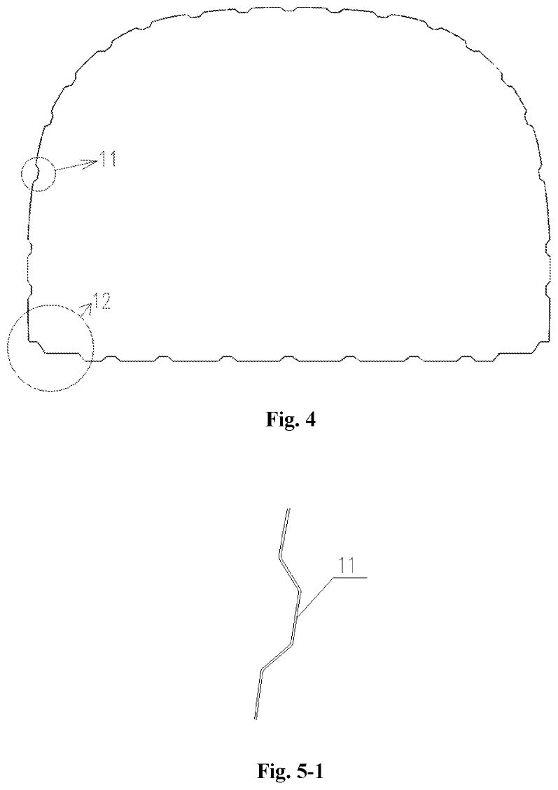

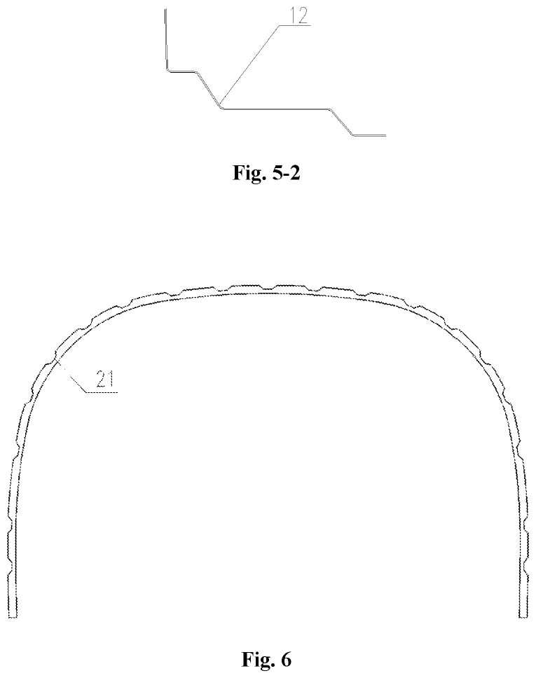

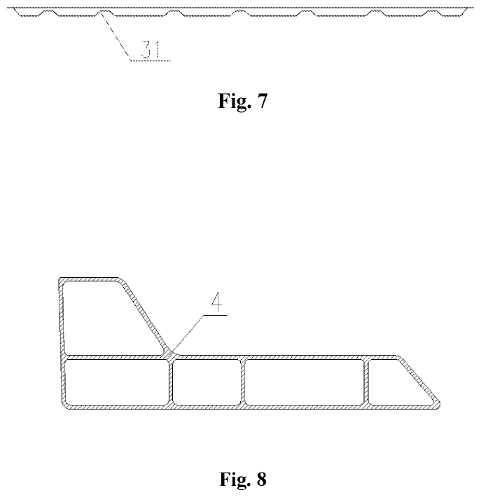

Referring to FIG. 1 to FIG. 8, FIG. 1 is a cross-sectional view of a rail vehicle body structure provided by a specific embodiment of the present application; FIG. 2 is a partial enlarged view of position A in FIG. 1; FIG. 3 is a cross-sectional view of the skin of the rail vehicle body structure provided by a specific embodiment of the present application; FIG. 4 is a cross-sectional view of a corrugated plate of a rail vehicle body structure provided by a specific embodiment of the present application; FIG. 5-1 and FIG. 5-2 are respectively partial enlarged views of positions 11 and 12 in FIG. 4; FIG. 6 is a cross-sectional view of an annular beam of a rail vehicle body structure provided by a specific embodiment of the present application; FIG. 7 is a cross-sectional view of an underframe cross beam of a rail vehicle body structure provided by a specific embodiment of the present application; FIG. 8 is a cross-sectional view of an underframe side beam of a rail vehicle body structure provided by a specific embodiment of the present application.

In a specific embodiment, the rail vehicle body structure provided by the present application includes a cylindrical corrugated plate 1; an annular beam 2 and an underframe cross beam 3 nested inside the corrugated plate 1; and an underframe side beam 4 arranged between the annular beam 2 and the underframe cross beam 3; a pair of interface parts 12 are symmetrically arranged on both sides of the bottom of the corrugated plate 1, and the underframe side beams 4 are arranged outside the pair of interface parts 12.

In the rail vehicle body structure provided by the present application, a connecting plate 6 is provided on an inner side of the bottom of the rail vehicle body structure. The annular beam 2 is connected with the connecting plate 6 by rivets or bolts, and the underframe side beam 4, the corrugated plate 1 and the connecting plate 6 are connected by rivets or bolts, and a sealant may be applied between the annular beam 2 and the connecting plate 6 and between the underframe side beam 4, the corrugated plate 1 and the connecting plate 6 at the same time. A skin 5 is laid outside the corrugated plate 1 and the underframe side beam 4. The corrugated plate 1 is provided with multiple ribs 11, and the positions of the ribs 11 may be determined according to the interior decoration, equipment interface and strength requirements. The annular beam 2 and the underframe cross beam 3 are used for improving the rigidity and strength of the vehicle body. The annular beam 2 is provided with a rib passage notch 21 at a position corresponding to each of the multiple ribs 11, and the underframe cross beam 3 is provided with a rib passage notch 31 at a position corresponding to the rib 11. An equipment mounting part 7 is riveted on the underframe side beam 4, and the equipment mounting part 7 is provided with a sliding groove 71 for providing the equipment interface, and the shape of the sliding groove 71 may be varied according to specific requirements. The corrugated plate 1, the annular beam 2, the underframe cross beam 3, the underframe side beam 4 and the skin 5 are all made of carbon fiber composite materials.

The rail vehicle body structure provided by the present application is a cylindrical integrally-formed structure, and the skin 5 and the corrugated plate 1 are integrally formed by adopting an automatic laying technology, and the underframe side beam 4 is arranged between the skin 5 and the corrugated plate 1, and the connection strength is high.

The manufacturing process of the rail vehicle body structure provided by the present application is as follows: pre-forming the cylindrical corrugated plate 1 by the automatic laying technology, and after the pre-forming, placing a sandwich material (the sandwich material may be foam or paper honeycomb) at the rib 11, and placing the underframe side beam 4 at each of two sides, and then automatically laying the skin 5 at an outside, and then performing an integral curing and formation, finally, placing the annular beam 2 and the underframe cross beam 3, and finally performing a secondary curing.

The above embodiments are only preferred embodiments of the present application. It should be noted that, for those skilled in the art, other improvements and modifications may be further made without departing from the principle of the present application, and these improvements and modifications should also be deemed as falling into the protection scope of the present application.

What is claimed is:

1. A rail vehicle body structure, comprising a cylindrical corrugated plate;
an annular beam and an underframe cross beam sleeved inside the corrugated plate; and,
an underframe side beam arranged between the annular beam and the underframe cross beam;
a pair of interface parts are symmetrically arranged on both sides of a bottom of the corrugated plate, and the underframe side beam is arranged outside each of the pair of interface parts.

2. The rail vehicle body structure according to claim 1, wherein a connecting plate is provided on an inner side of a bottom of the rail vehicle body structure.

3. The rail vehicle body structure according to claim 2, wherein the annular beam and the connecting plate are connected by rivets or bolts, and the underframe side beam, the corrugated plate and the connecting plate are connected by rivets or bolts.

4. The rail vehicle body structure according to claim 2, wherein a sealant is coated between the annular beam and the connecting plate, and between the underframe side beam, the corrugated plate and the connecting plate.

5. The rail vehicle body structure according to claim 1, wherein a skin is laid on an outside of the corrugated plate and the underframe side beam.

6. The rail vehicle body structure according to claim 1, wherein a plurality of ribs are provided on the corrugated plate.

7. The rail vehicle body structure according to claim 6, wherein the annular beam and the underframe cross beam are provided with a rib passage notch at a position corresponding to each of the plurality of ribs.

8. The rail vehicle body structure according to claim 1, wherein the underframe side beam is riveted with an equipment mounting part, and the equipment mounting part is provided with a sliding groove.

9. The rail vehicle body structure according to claim 5, wherein the corrugated plate, the annular beam, the underframe cross beam, the underframe side beam and the skin are all made of carbon fiber composite materials.

10. The rail vehicle body structure according to claim 3, wherein a sealant is coated between the annular beam and the connecting plate, and between the underframe side beam, the corrugated plate and the connecting plate.
